(19) United States
(12) Patent Application Publication
(10) Pub. No.: US 2003/0124277 A1
(43) Pub. Date: Jul. 3, 2003

(54) Elastic wrap

(76) Inventors: Naveen Agarwal, Atlanta, GA (US); Jeffrey Eldon Fish, Dracula, GA (US); Michael Scott Brunner, Roswell, GA (US); Bruce Scott Williamson, Alpharetta, GA (US)

Correspondence Address: KIMBERLY-CLARK WORLDWIDE, INC., 401 NORTH LAKE STREET, NEENAH, WI, 54956

(21) Appl. No.: 10/034,547

(22) Filed: Dec. 28, 2001

(51) Int. Cl. B32B 1/02

(52) U.S. Cl. 428/35.2; 428/100

(57) ABSTRACT

The present invention provides wraps that comprise a first thermal portion that contains a thermal agent, a second thermal portion that also contains a thermal agent, and an elastic portion connecting the first thermal portion to the second thermal portion.

### FIELD OF THE INVENTION

This invention relates to wraps for releasing heat to or absorbing heat from a body or body part. The wraps may be used to treat a variety of ailments by providing or absorbing heat. The treated body or body part may be the body or body part of a human or the body or body part of another animal.

### BACKGROUND

A common method of treating pain, particularly muscle and joint pain, is to apply heat or cold to the afflicted area. The application of heat or cold to an afflicted area has been used to relieve pain, muscle soreness, stiffness, inflammation, swelling, bruising, arthritis, cramping and stress, among other afflictions. Common methods and devices for applying heat or cold to a body or a body part include heating pads, whirlpools, hot tubs, hot towels, hot and cold water bottles, and ice packs. Compressive bandages, such as ACE bandages, have also been used to treat many of the same afflictions. However, compressive bandages have not been successfully combined with a heat or a cold source to provide a single and integrated compressive wrap that provides heat or cold uniformly to an applied body part without slipping or moving away from the area to which it is desired that the heat or cold be applied.

Although heating and cooling pads are known, neither heating nor cooling pads have been provided in an elastically extensible wrap that conforms well to various body parts without adding excessive bulk. What is needed is an easy-to-use elastically extensible thermal wrap that can transmit or absorb heat directly and efficiently to or from a body or a part of a body. What is also needed is an elastically extensible wrap that drapes well, conforms to various body parts and provides compression to a wrapped body part. It would be desirable to provide elastically extensible thermal wraps that can be adjusted to provide comfortable and therapeutic compression. It would also be desirable to provide elastically extensible, thermal wraps that have increased breathability.

Disposable heat packs have been developed that take advantage of iron oxidation chemistry, for example, U.S. Pat. Nos. 4,268,272, 4,282,005, 4,649,895 and 5,046,479. However, these devices are not totally satisfactory. The devices suffer from one or more of the following disadvantages or deficiencies. The devices are not reusable and the devices do not conform well to various body parts.

Others have attempted to overcome these deficiencies. U.S. Pat. Nos. 6,020,040 and 6,146,732 describe a disposable thermal wrap material that comprises densely packed heat cells fixedly attached to a continuous layer of a co-extruded film that is semirigid at room temperature, about 25° C., and is less rigid at elevated temperatures, at about 45° C. and above. Although the wraps are described as less rigid at elevated temperatures, the heat cells are not flexible and do not stretch. Thus, the wraps are not readily flexible and do not conform well to various body contours. These wraps must be designed for a specific body part, see for example: U.S. Pat. No. 5,741,318 “Elastic Back Wrap”; U.S. Pat. No. 5,906,637 “Disposable Elastic Thermal Uniaxial Joint Wrap”; U.S. Pat. No. 5,925,072 “Disposable Elastic Thermal Back Wrap”; and U.S. Pat. No. 6,102,937 “Disposable Thermal Neck Wrap”. Significantly, a wrap that is designed for one body part, for example, a neck wrap, is ill suited for use on another body part, for example, an elbow. Furthermore, these wraps are not uniformly stretchable and elastic, do not apply compression to a body site and are have limited breathability.

U.S. Pat. No. 3,687,143 provides a heatable bandage that is made from a single electrical element enveloped between two rubber sheets that are adhered around the electrical element. The bandage must be connected to a power source in order to provide current to the electrical element and thus provide heat. The use of an electrical power source proximal to human skin is not desirable. Furthermore, the rubber sheets that are needed to electrically insulate the electrical element from the wearer are not breathable and do not provide a “clothlike” feel or comfort level.

U.S. Pat. No. 4,586,506 provides an elastic wrap that is made from an elongated strip of elastic fabric to which is attached a flexible-walled container for housing a removable hot or cold pack. The flexible-walled container and the hot or cold pack are not elongatable and do not conform to the body part to which they are wrapped. Furthermore, the flexible walled container and the hot or cold pack are not breathable, do not provide a “clothlike” drape and have high bulk.

U.S. Pat. No. 4,805,620 provides an adjustable wrap that is a retention device for a hot or cold liquid pack. The wrap is made from an elongated strip of elastic fabric to which is attached a flexible-walled container for housing a removable hot or cold pack. The flexible-walled container and the hot or cold pack are not elongatable and do not conform to the body part to which they are wrapped. Furthermore, the adjustable wrap is made of neoprene and is not breathable and does not provide “clothlike” drape or feel.

The previously developed thermal wraps have failed to gain widespread consumer acceptance. Low commercial acceptance may be attributed to any one of the following disadvantages. The wraps are inconvenient to use, provide inconsistent or little thermal benefit, or are generally not very comfortable or efficient. The thermal wraps that do provide more than one thermal pocket or thermal zone are not as flexible as desirable and do not provide areas or zones of elasticity between the thermal pockets or zones. Therefore, there is a need to provide a wrap and a thermal source in a single, integrated product that adapts and conforms to a variety of body parts and sizes, has fabric-like drape and/or has improved breathability to provide an easy-to-use and comfortable thermal therapy.

Definitions

The term “elastic” is used herein to mean any material that upon application of a tensioning or elongating force is stretchable and elongatable by at least about 40 percent (i.e., to a stretched, elongated length which is at least about 140 percent of its relaxed unstretched length), and which, will recover to at least within 10 percent of its relaxed, unstretched length upon release of the stretching or elongating force. A hypothetical example would be a one (1.00) inch sample of a material which is elongatable to at least 1.40 inches and which, upon being elongated to 1.40 inches and released, will recover to a length of not more than 1.10 inches. Many elastic materials may be elongated by much more than 40 percent (i.e., much more than 140 percent of their relaxed length), for example, elongated by 50 to 100 percent or more, and many of these will recover to substantially their initial relaxed length, for example, to within 10 to 5 percent of their original relaxed length, upon release of the stretching force.

The term “nonelastic” as used herein refers to any material that does not fall within the definition of “elastic,” above.

The term “machine direction” (MD) as used herein refers to the planar dimension of a sheet or a web that is in the direction of travel of the forming surface onto which fibers are deposited during formation of the web.

The term “crossmachine direction” (CD) as used herein refers to the planar dimension of a sheet or a web of material that is in the direction that is perpendicular to the machine direction defined above.

The term “Z-direction” as used herein refers to the thickness direction of a sheet of material, that is, the direction perpendicular to the plane of the length and width dimensions.

As used herein, the term “disposable” is not limited to single use articles but also refers to articles that can be discarded if they become soiled or otherwise unusable after only a few uses.

The term “composite elastic material” as used herein refers to an elastic material which may be a multicomponent material or a multilayer material. For example, a multilayer material may have at least one elastic layer joined to at least one gatherable layer at least at two locations so that the gatherable layer is gathered between the locations where it is joined to the elastic layer. Such a multilayer composite elastic material may be stretched to the extent that the nonelastic material gathered between the bond locations allows the elastic material to elongate. This type of multilayer composite elastic material is disclosed, for example, by U.S. Pat. No. No. 4,720,415 to VanderWielen et al., issued Jan. 19, 1988, which is hereby incorporated by reference.

The term “stretch-to-stop” as used herein refers to a ratio determined from the difference between the unextended dimension of a composite elastic material and the maximum extended dimension of a composite elastic material upon the application of a specified tensioning force and dividing that difference by the unextended dimension of the composite elastic material. If the stretch-to-stop is expressed in percent, this ratio is multiplied by 100. For example, a composite elastic material having an unextended length of 5 inches and a maximum extended length of 10 inches upon applying a force of 2000 grams has a stretch-to-stop (at 2000 grams) of 100 percent. Stretch-to-stop may also be referred to as “maximum non-destructive elongation.” Unless specified otherwise, stretch-to-stop values are reported herein at a load of 2000 grams. An exemplary method of measuring stretch-to-stop is given in Comparative Example 2 of U.S. Pat. No. 5,503,908 issued Apr. 2, 1996 to Faass and which is hereby incorporated by reference.

As used herein, the term “nonwoven web” means a web having a structure of individual fibers or threads which are interlaid, but not in an identifiable, repeating manner. Nonwoven webs have been, in the past, formed by a variety of processes such as, for example, meltblowing processes, spunbonding processes and bonded carded web processes.

As used herein, the term “autogenous bonding” means bonding provided by fusion and/or self adhesion of fibers and/or filaments without an applied external adhesive or bonding agent. Autogenous bonding may be provided by contact between fibers and/or filaments while at least a portion of the fibers and/or filaments are semimolten or tacky. Autogenous bonding may also be provided by blending a tackifying resin with thermoplastic polymers used to form fibers and/or filaments. Fibers and/or filaments formed from such a blend can be adapted to selfbond with or without the application of pressure and/or heat. Solvents may also be used to cause fusion of fibers and filaments which remains after the solvent is removed.

As used herein, the term “meltblown fibers” means fibers formed by extruding a molten thermoplastic material through a plurality of fine, usually circular, die capillaries as molten threads or filaments into a high velocity gas (e.g. air) stream which attenuates the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, the disclosure of which is hereby incorporated by reference.

As used herein, the term “microfibers” means small diameter fibers having an average diameter not greater than about 100 microns, for example, having an average diameter of from about 0.5 microns to about 50 microns, or more particularly, microfibers may have an average diameter of from about 4 microns to about 40 microns.

As used herein, the term “spunbonded fibers” refers to small diameter fibers which are formed by extruding a molten thermoplastic material as filaments from a plurality of fine, usually circular, capillaries of a spinnerette with the diameter of the extruded filaments then being rapidly reduced as by, for example, eductive drawing or other well known spunbonding mechanisms. The production of spunbonded nonwoven webs is illustrated in patents such as, for example, in U.S. Pat. No. 5,382,400 to Pike et al., U.S. Pat. No. 4,340,563 to Appel et al., U.S. Pat. No. 3,802,817 to Matsuki, and U.S. Pat. No. 3,692,618 to Dorschner et al. The disclosures of these patents are hereby incorporated by reference.

As used herein, the term “polymer” generally includes, but is not limited to, homopolymers, copolymers, such as, for example, block, graft, random and alternating copolymers, terpolymers, etc. and blends and modifications thereof. Furthermore, unless otherwise specifically limited, the term “polymer” shall include all possible geometrical and spatial configurations of the material. These configurations include, but are not limited to, isotactic, syndiotactic and random symmetries.

As used herein, “neck bonding” refers to the process wherein an elastic member is bonded to a non-elastic member while only the non-elastic member is extended or necked so as to reduce its dimension in the direction orthogonal to the extension. “Neck bonded laminate” refers to a composite elastic material made according to the neck bonding process, i.e.: the layers are joined together when only the non-elastic layer is in an extended condition. Such laminates usually have cross directional stretch properties. Examples of neck-bonded laminates are such as those described in U.S. Pat. Nos. 5,226,992, 4,981,747, 4,965,122 and 5,336,545 to Morman and U.S. Pat. No. 5,514,470 to Haffner et al.

As used herein, “stretch bonding” refers to a process wherein an elastic member is bonded to another member while only the elastic member is extended at least about 25 percent of its relaxed length. “Stretch bonded laminate” refers to a composite elastic material made according to the stretch bonding process, i.e. the layers are joined together when only the elastic layer is in an extended condition so that upon relaxing the layers, the nonelastic layer is gathered. Such laminates usually have machine directional stretch properties and may be stretched to the extent that the nonelastic material gathered between the bond locations allows the elastic material to elongate. One type of stretch bonded laminate is disclosed, for example, by U.S. Pat. No. 4,720,415 to VanderWielen et al., in which multiple layers of the same polymer produced from multiple banks of extruders are used. Other composite elastic materials are disclosed in U.S. Pat. No. 4,789,699 to Kieffer et al., U.S. Pat. No. 4,781,966 to Taylor and U.S. Pat. Nos. 4,657,802 and 4,652,487 to Morman and 4,655,760 to Morman et al.

As used herein, “neck-stretch bonding” generally refers to a process wherein an elastic member is bonded to another member while the elastic member is extended at least about 25 percent of its relaxed length and the other layer is a necked, non-elastic layer. “Neck-stretch bonded laminate” refers to a composite elastic material made according to the neck-stretch bonding process, i.e.: the layers are joined together when both layers are in an extended condition and then allowed to relax. Such laminates usually have omni-directional stretch properties.

As used herein, “vertical filament” refers to the process wherein a nonwoven layer is bonded to substantially parallel elastic filaments with an adhesive that is applied in a nonrandom pattern of adhesive lines intersecting both the elastic filaments and themselves to form a bonding network. “Vertical filament laminate” refers to a composite nonwoven material made according to the vertical filament process, i.e.: a nonwoven layer and substantially parallel elastic filaments are joined with nonrandom adhesive lines. Examples of vertical filament laminates are described in PCT International Publication Nos. WO 01/87589 and WO 01/88245.

### SUMMARY

The present invention provides elastically extensible thermal wraps that transmit or absorb heat directly and efficiently to or from a variety of bodies and body parts. In one embodiment, the present invention provides a wrap that comprises a first thermal portion containing a thermal agent, a second thermal portion containing a thermal agent, and an elastic portion connecting the first thermal portion to the second thermal portion. In another embodiment, the present invention provides a thermal wrap formed from two elastic sheets joined together to form a plurality of pockets around a thermal agent. Wraps of the present invention may be provided in or on a roll. A roll may comprise one or more wraps that can be separated along a line of perforations.

In several desirable embodiments, wraps of the present invention, or the elastic portions of the wraps are stretchable and elongatable by at least about 50 percent upon application of an elongating force and will return to within 10 percent of its original length upon release of the elongating force, more desirably to within 5 percent of the original length. Wraps of the present invention or the elastic portions thereof may be stretchable and elongatable by at least about 100, more desirably at least about 200 percent.

In at least one embodiment, the present invention provides an elastically extensible wrap that drapes well, conforms to various body parts and provides compression to the wrapped body part without excessive bulk. Advantageously such a wrap can be adjusted to vary the compression. Compression may be desirable for a cold wrap, that is, a wrap that absorbs heat. In another embodiment, the present invention provides elastically extensible, thermal wraps that have increased breathability and moisture permeability to reduce moisture buildup against the wearer's skin. In another embodiment, the present invention provides a roll of thermal wrap material that is not substantially larger than a conventional roll of compression wrap material of the same dimensions. A roll of thermal wrap material can be easily applied to a body part by winding the wrap material around a body part several times. Desired compression is achieved in the wrapping process. In yet another embodiment, the roll of thermal wrap material can be subdivided along perforations that are provided along the length of a roll of thermal wrap material to allow a user of the material to select a desired length of wrap material.

Features, aspects and advantages of the present invention will become better understood with reference to the following description and the appended claims. The accompanying drawings, which are incorporated in and constitute a part of this specification, illustrate several examples of the invention and, together with the description, serve to explain the principles of this invention.

### BRIEF DESCRIPTION OF THE FIGURE

The invention is hereinafter more particularly described by way of examples with reference to the following drawings in which:

FIG. 1 is a top plan view of a wrap.

FIG. 1A is a sectioned side elevation view of the wrap of FIG. 1 taken though line 1A-1A.

FIG. 2 is a top plan view of a wrap.

FIG. 2A is a sectioned side elevation view of the wrap of FIG. 2 taken though line 2A-2A.

FIG. 3 is a top plan view of a wrap.

FIG. 3A is a sectioned side elevation view of the wrap of FIG. 3 taken though line 3A-3A.

FIG. 4 is a top plan view of a wrap.

FIG. 4A is a sectioned side elevation view of the wrap of FIG. 4 taken though line 4A-4A.

FIG. 5 is a top plan view of a wrap.

FIG. 5A is a sectioned side elevation view of the wrap of FIG. 5 taken though line 5A-5A.

FIG. 6 is a top plan view of a wrap.

FIG. 6A is a sectioned side elevation view of the wrap of FIG. 6 taken though line 6A-6A.

FIG. 7 is a top plan view of a wrap.

FIG. 7A is a sectioned side elevation view of the wrap of FIG. 7 taken though line 7A-7A.

FIG. 8 is a top plan view of a wrap.

FIG. 8A is a sectioned side elevation view of the wrap of FIG. 8 taken though line 8A-8A.

FIG. 9 is a sectioned side elevation view of an additional embodiment of a wrap.

### DETAILED DESCRIPTION

The present invention provides elastic, thermal wraps that incorporate an elastic material and one or more thermal portions that contain a thermal agent in a single easy-to-use product. The thermal portions may comprise pockets of a thermal agent. Such wraps can be used to directly and efficiently transmit heat to or absorb heat from a body or a part of a body. As used herein, “thermal wraps” include wraps that can provide thermal therapy by releasing or absorbing heat.

Wraps of the present invention conform readily and easily to most body contours, such as backs, knees, wrists, shins and so forth and can be used to relieve back pain and joint pain, relax back and neck muscles, and to relieve headaches, carpel tunnel syndrome, shin splints, and so forth. The wraps may also be used on non-human bodies and portions thereof and on inanimate objects such as water pipes and containers. For example, wraps can be used on horses, particularly shins and forelegs of horses, or on body parts of injured animals or to wrap a water pipe to protect the water pipe from freezing. Advantageously, wraps of the present invention are easy and convenient to use. For example, the wraps described herein have low bulk and are flexible so that a wrap may be concealed by an individual under normal clothing and without greatly restricting movement or comfort of the individual wearing the wrap. Desirably, the wraps of the present invention have improved drapability and are fabric-like.

Wraps of the present invention are elastically extensible and can be stretched to wrap around a body part. Specifically, wraps of the present invention are stretchable and elongatable by at least about 40 percent upon application of a biasing force that can be produced by an average adult human. Desirably, a wrap of the present invention can be stretched to an elongated, stretched length which is at least about 140 percent of its relaxed unbiased length and will recover to within 10 percent of its original, unstretched length upon release of the stretching, elongating force. A hypothetical example would include a 3.0-foot wrap that is elongatable to at least 4.2 feet and which, upon being elongated to 4.2 feet and released, will recover to a length of not more than 3.30 feet. More desirably, a wrap of the present invention may be elongated by significantly more than 40 percent (i.e., more than 140 percent of its relaxed length). For example, a wrap of the present invention may be elongated by about 50 to 100 percent or more, more desirably about 200 percent or more, and will recover to substantially its initial relaxed length, for example, to within about 5 or 10 percent of its original relaxed length, upon release of the stretching force.

Compression is desirable when applying cold therapy and is accomplished by stretching a wrap around a specific body part at a desired tension. The tension may be maintained by friction and/or a closure or other means of retaining. When properly wrapped around a body part, a wrap of the present invention may be used to apply both thermal and compressive therapy to a body part for pain relief, prevention of swelling, circulation enhancement and so forth. Many of the wraps described herein drape and conform well to the body of the user, decreasing bulk and ensuring intimate contact and efficient transfer of heat between the wrap and the body part to which the wrap has been applied. Intimate contact also minimizes the relative movement between the wearer and the wrap, decreasing abrasion, chafing and so forth. It is particularly desirable for wraps to have fabric-like drape and good conformability.

Wraps of the present invention are elastically extensible and comprise an elastic portion. The elastic portion may comprise an elastically-extensible base material or layer. Elastically-extensible base materials and layers include any material that upon application of a stretching or elongating force is stretchable and elongatable by at least about 40 percent (i.e., to a stretched, biased length which is at least about 140 percent of its relaxed unbiased length), and which, will recover to within 10 percent of the its original unstretched length upon release of the stretching, elongating force. Exemplary elastically-extensible materials include, but are not limited to, neck bonded laminates (NBL), stretch bonded laminates (SBL), neck-stretch bonded laminates (NSBL), vertical filament laminates (VFL), LYCRA, KRATON, latex films and other elastic films or sheet materials that can be stretched by at least about 40 percent and return to within about 10 percent to their original lengths, desirably materials that can be stretched to at least about 100 percent and return to within 5 percent of their original length.

Elastically-extensible materials are known to those of skill in the art and include, but are not limited to, the elastically-extensible materials specifically disclosed herein. Desirable elastically-extensible base materials include materials that are elastically extensible in the machine direction of the material so that the machine-direction of the base material may be used to form the length of the wrap. Thus, wraps can be manufactured in the machine direction so that the length of a wrap will stretch easily around and conform to a body part providing compression to and intimate contact with the body part that is wrapped.

Optionally, but desirably, the elastically-extensible base material, and more desirably the overall wrap, is breathable and permeable so as to minimize perspiration and allow the passage of water. Such wraps and materials provide for evaporation of sweat and condensation. Wraps with increased breathability provide increased comfort to the wearer by preventing excess moisture buildup between the skin of the wearer and the wrap. Exemplary breathable, elastic materials and methods of making such breathable, elastic materials are described in U.S. Pat. Nos. 5,366,793, 5,385,755 and 5,503,908, all of which are hereby incorporated by reference herein in their entirety. Many of the materials described in these patents may be used to apply compressive force to the body part around which the materials are wrapped. Furthermore, these materials are generally soft and breathable, provide flexible support, a soft, cushiony feel, have good drape, are easy to apply, durable, and water-resistant. The elastic base material described in U.S. Pat. No. 5,503,908 is self adhesive and comprises a self-adhesive material on at least a portion of at least one exterior surface of the elastic material. In an optional embodiment, self-adhesive material may be provided on at least a portion of at least one exterior surface of the body side of a wrap to facilitate positioning of the wrap.

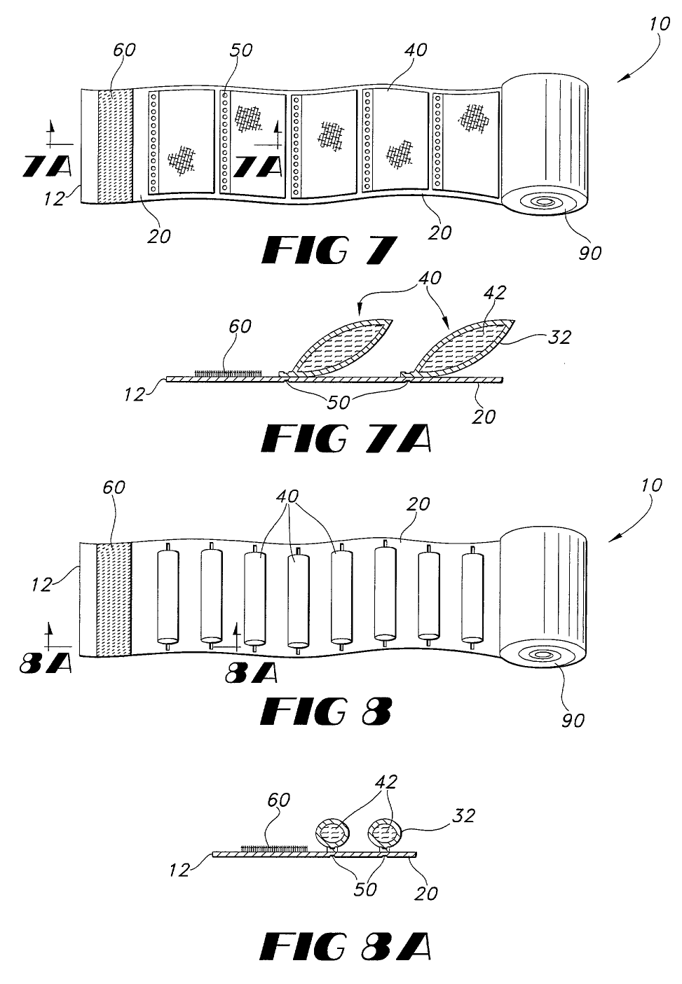

Thermal portions containing a thermal agent are connected to or formed from the elastic portion. The thermal portions may be separate structures such as pockets containing a thermal agent that are attached or preferably partially attached to the wrap or base material. For example, a pocket may be attached to an elastic wrap along one edge of the pocket as illustrated in FIGS. 7-9. The pockets may be made of the same material as the base sheet material or, because the pockets are only partially attached to the elastic base sheet, can be made of a non-elastic material. If the pockets forming the thermal sections are not elastic, it is desirable to minimize the effect of the attachment of the pockets to the elastic section by minimizing the points of attachment and the bonds in the direction of the length of the wrap to preserve the elasticity of the wrap in the long direction.

Thermal agents include any materials that generate heat or absorb heat and also include any materials that may be precooled or preheated so as to transfer heat to or from a body portion that is placed proximal the heat transfer material. Heat transfer materials and wraps comprising heat transfer materials may be heated, for example, by placing the wrap and heat transfer material in a microwave oven, a conventional oven and so forth. Thermal agents and wraps comprising thermal agents may be cooled, for example, by placing the wrap and thermal agent in a source of refrigeration, such as a refrigerator, a freezer and so forth. Thermal agents include, but are not limited to: heat transfer materials such as ceramic beads; natural grains such as rice, wheat, corn, barley and birdseed; water and generally all compositions containing water that can be heated; gels; iron powder mixtures that may further comprise salt, water, vermiculite, and/or carbon; mixtures of calcium chloride and water; mixtures of ammonium nitrate and water; any materials that generate or absorb heat, and any other materials that once heated retain the heat for a period of time, or once cooled remain cool for a period of time.. Materials that have high heat capacities are desirable thermal agents. Exemplary thermal agents that act as heat transfer materials include, but are not limited to: ceramic beads, natural grain (wheat, corn, rice, barley, beans, peas, etc.), mineral, water, gel, hydrogel. Natural grains contain water and can absorb and release heat.

Wraps of the present invention may also include optional active agents that provide some additional benefit to a wearer of a wrap of the present invention. As used herein, an “active agent” is a substance or composition that causes a perceptible change, such as release an aromatic compound. Active agents may be incorporated to provide an additional actual or perceived benefit. For example, an active agent may release an aromatic compound, absorb or release moisture and so forth. Exemplary aromatic agents include, but are not limited to, essential oils, typically aromatic essences from plants, that may be used to maintain and promote physical, psychological, and spiritual wellbeing. Some exemplary essential oils include, but are not limited to, lavender oil, wintergreen oil, clove oil, black pepper oil, menthol, camphor oil, and so forth. An active agent may be included with the wrap at the time of manufacture or can be added to a wrap at a later time.

The thermal agent may be contained within a pocket formed from the elastic material from which the wrap is formed or may be contained within a pocket formed from another material that is not necessarily elastically extensible to further protect and contain the heat transfer material. The pockets can be made of any material including materials that are non-stretchable including, but not limited to, polymer films, meltblown (MB) materials, spunbonded (SB) materials, spunbonded/meltblown (SM) laminates, spunbonded/meltblown/spunbonded (SMS) laminates, spunbonded/film (SF) laminates, spunbonded/film/spunbonded (SFS) laminates, woven cloth and so forth. Spunbonded/meltblown/spunbonded (SMS) laminates can be formed by well known methods, as disclosed in U.S. Pat. No. 5,213,881 issued to Timmons et al. and assigned to Kimberly-Clark Worldwide, the disclosure of which is herein incorporated by reference. Examples of these nonwoven web laminates are also disclosed in U.S. Pat. No. 4,041,203 to Brock et al., U.S. Pat. No. 5,169,706 to Collier, et al, and U.S. Pat. No. 4,374,888 to Bornslaeger which are all herein incorporated by reference. Non-stretchable SMS laminates can be made using inelastic polypropylene.

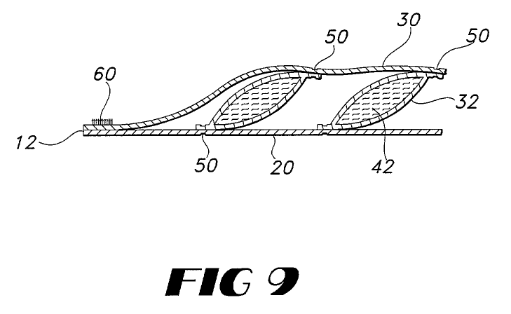

In one embodiment, the invention provides a wrap 10 formed from a continuous sheet of elastic material 20 to which are attached pockets 40 containing thermal agent 42. It is particularly desirable that the pockets containing the thermal agent are partially attached to the elastically extensible base sheet along only a portion of the perimeter of the pocket, for example only along one edge of the pockets 50 to preserve the elasticity of the base sheet. Other examples of wraps in which pockets containing a thermal agent are partially attached to the material that forms the base and length of the wrap are illustrated in FIGS. 8 and 9.

In these illustrated embodiments, the invention includes a thermal wrap comprising individual pockets attached to the wrap or the base material that forms the length of the wrap at only a portion of the perimeter or the pocket. In the embodiment illustrated in FIG. 7, the pockets 40 are essentially rectangular in shape and are sealed about their edges to contain the thermal agent. Each pocket is attached to the wrap along one edge of the pocket. The other sides of the pockets are free and are not attached to the wrap or the base material that forms that length of the wrap. In FIG. 7, the pockets are attached to the base sheet using linear bonds or a line of bonding points in the cross-machine direction at one edge only. This configuration allows the wrap to retain the elasticity of the base sheet even if the pockets are made of a less elastic material.

The wrap 10 illustrated in FIGS. 7 and 7A comprises an elastic base sheet 20 to which are attached at regularly spaced interval pockets 40. The pockets or thermal sections may be spaced evenly across the length of the wrap 10, irregularly, or concentrated at one or toward one end of the wrap 12. The rectangular pockets 40 are attached to the base sheet 20 along a single edge 50 and contain a heat transfer material 42. Each pocket 40 may be made from one sheet of material or from two sheets of material 32. The edges of the pockets may be bonded or sewn at intervals that are smaller than the diameter or the heat transfer particles or the heat transfer particles may be further contained in another pocket or package that can be contained within the pockets 40 in order to prevent the heat transfer material 42 from exiting out of the pockets.

The pockets may be of a variety of shapes and sizes other than rectangular, for example square, triangular, trapezoidal, circular, oblong and so forth. However, it is desirable to size the pockets less than the width of the wrap, as illustrated in FIGS. 7-9, so that the pockets are concealed by the wrap in use and compressed against the body to ensure intimate contact between the pockets and the body of the wearer. The pockets 40 of the wrap 10 illustrated in FIGS. 8 and 8A are tubular or finger-like in shape and may be formed from a continuous cylinder of a material that is cut into sections, sealed on one end, filled with a heat transfer material and sealed on the other end to form a pocket. In the embodiment illustrated in FIGS. 8 and 8A, the finger-shaped pockets 40 are point bonded to the elastic base sheet 20 at their ends.

The wraps of present invention are elastically extensible and can be stretched around various body parts, for example the lower back, to provide intimate contact between the wrap and the wearer's lower back. The wraps of the present invention contain a thermal agent that is designed to release or absorb heat and are adaptable to a variety of chemistries and configurations. Materials and compositions that release heat and materials and compositions that absorb heat are known to those of skill in the art. A few exemplary compositions that may be used as thermal agents that release heat are described in U.S. Pat. Nos. 4,268,272, 4,282,005, 4,649,895 and 5,046,479. A few exemplary compositions that may be used as thermal agents that absorb heat are described in U.S. Pat. Nos. 4,081,256, 4,462,244 and 5,211,949. Alternatively, wraps of the present invention may be provided with a heat transfer material that has a high heat capacity.

The thermal sections may be pockets or cells that contain one or more of a variety of thermal agents including, but not limited to: exothermic compositions, such as, mixtures comprising calcium chloride and water, iron and oxygen, sodium thiosulfate, and sodium acetate; endothermic compositions, such as mixtures comprising ammonium nitrate and water; microwaveable compositions, including seed-type products such as rice, corn, beans and so forth; heat of crystallization compositions; ceramic beads, phase change materials; and so forth. Seed-type products contain a small amount of moisture and can be heated by microwaves or other heat sources or can be cooled by refrigeration. Seed-type products are advantageous because seed-type products have small grain size and are natural and safe. It is highly desirable that the thermal sections, pockets or cells are flexible, contain small grains or particles, and conform to the body part around which the pockets are wrapped. It is also highly desirable that regions between cells stretch readily and uniformly.

In one embodiment, each thermal section comprises a pocket or cell that contains a thermal cell that is self-contained and operates independently of other similar cells. Specifically, the content of each cell is an individual, unitary thermal pack that either produces or absorbs heat. If the contents of the cell are contained in a film or impermeable material that is not as stretchable as the base material or wrap, it is recommended that the film or other cell covering is not continuous from cell to cell so that the overall elasticity of the wrap is maximized.

In one embodiment, the thermal sections contain hot or cold chemical packs that can be activated by pressing on, kneading, stretching, twisting or otherwise applying pressure, tension, or shear force to the packs or pockets. Hot and cold chemical packs that are activated by pressing on, kneading, twisting or otherwise applying pressure, tension or shear force to the pack are disclosed and described in U.S. Pat. Nos. 5,792,213 and 5,967,308 which are hereby incorporated by reference herein. Packs described in U.S. Pat. Nos. 5,792,213 and 5,967,308 comprise compartments that are separated by a frangible barrier that can be broken to bring components contained in the compartments into contact with each other to react. The components can be selected so that the reaction is exothermic, heat-producing, or endothermic, cooling. Alternatively, the contents of the pockets may be thermal agent that is a heat transfer material. A heat transfer material is a material that can be either heated or cooled and will transfer heat to or absorb heat from a surrounding body. Advantages of heat transfer materials include that they may be reused over and over and may be used for both heating or cooling.

Reactive materials, that is materials or compositions which undergo an endothermic or exothermic reaction when activated, may be the thermal agent. Components of such compositions may be gas, liquid, or solid, and may be isolated until activation by confining in a film or other separation material. Components may be combined to initiate reaction by rupturing a membrane, squeezing, twisting, or compressing. Air or water may be one of the reactants. The reaction may be chemical, a phase change such as crystallization, hydration, oxidation, and so forth.

Wraps of the present invention may be provided with one or more closures 60 or one or more other means for retaining the wrap in place. Exemplary closures include any retaining means for holding a wrap in a desired position about a body or body part and include fasteners, the hook portion of hook and loop fasteners such as VELCRO brand hook and loop fasteners, adhesives, mechanical fasteners such as buttons, zippers, ties, snaps, barbs, and so forth. Closures and retaining means may be provided to maintain tension and/or to facilitate positioning and application of the wrap to various parts of the body, such as a back, a knee and so forth, permitting a wrap to be applied to various shapes and sizes of parts of bodies. Adhesive such as the self-adhesive layer on the cohesive bandages manufactured by Kimberly-Clark Corporation described in U.S. Pat. No. 5,503,908 may be used as a closure.

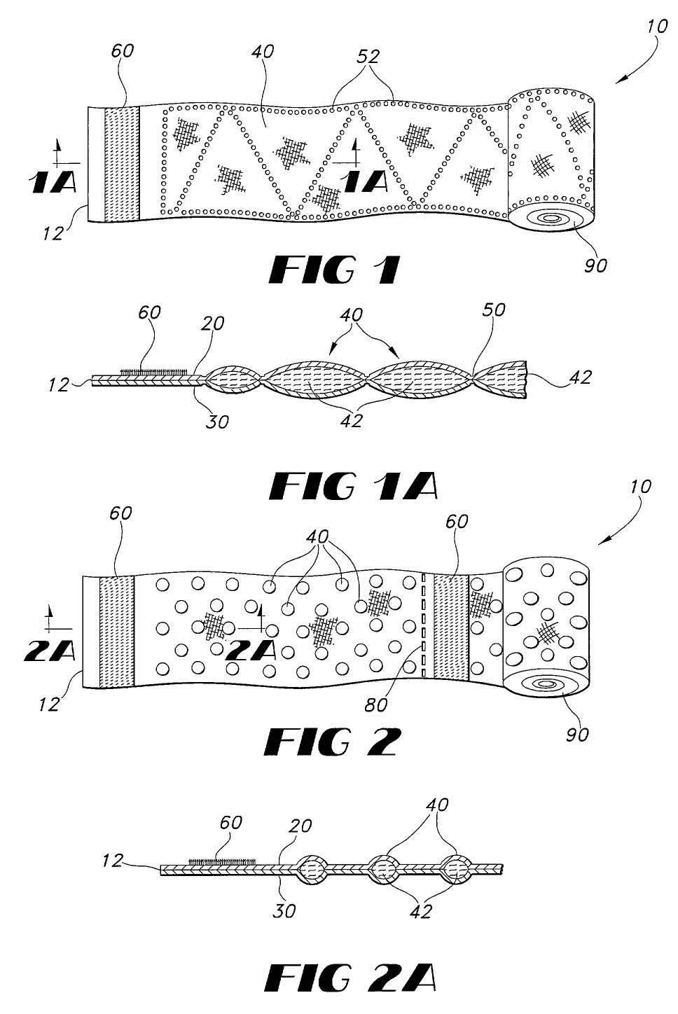

The wrap may be rolled onto itself or a core to provide a small and convenient roll 90. For example, in at least one desirable embodiment, a three-foot wrap can be provided in a 2-inch diameter roll. Desirably, a plurality of wraps is provided in a single roll as illustrated in FIG. 2. A single roll can be manufactured that is several feet in length and that comprise one or more lines of weakness, such as a line of perforations 80, across the roll at regular intervals so that a larger roll of wrap can be divided into shorter lengths as desired. A single roll that comprises a plurality of wraps can be provided by including perforations across the width of the wrap material. For example, a row of perforations may be placed across the width of wrap material at 6, 10, 12, 14 or 16-inch intervals to provide a plurality of wraps that can be selected in various lengths. A 12-24 inch long wrap may be desired for a wrap to cover an average wrist or ankle. A 20-48 inch wrap may be useful for wrapping a bicep or thigh. Longer lengths may be needed to wrap a back or stomach muscles. The perforations should be situated so that they do not interfere or overlap with the pockets.

Although wraps of the present invention provide thermal insulation, the wraps may further comprise one or more optional insulative layers or some other type of insulation to decrease heat loss transfer and to increase efficiency and duration of the wrap. Additional insulation may be used to control heat transfer to or from the skin and may be used to minimize heat transfer to air or the non-body side of the wrap. Furthermore, wraps may be provided with more thermal sections or thermal agent concentrated at one end so that the remaining end of the wrap with less thermal sections or thermal material can be used to provide support and insulation.

Wraps of the present invention can be manufactured by various methods including high-speed continuous manufacturing processes. Pockets containing thermal agent can be made and partially attached to the base sheet using bonding. Components of the wraps may be joined by any known method of bonding component materials including thermal bonding, ultrasonic bonding, adhesive bonding and physical bonding methods such as sewing. Components of the wrap may include, but are not limited to, combinations of an enclosing material, an elastic material, a thermal mass, a reactive material, which generates or takes in heat, and a means for fastening.

While various patents and other reference materials have been incorporated herein by reference, to the extent there is any inconsistency between incorporated material and that of the written specification, the written specification shall control. In addition, while the invention has been described in detail with respect to various specific examples, illustrations and embodiments thereof, it will be apparent to those skilled in the art that various alterations, modifications and other changes may be made to the invention without departing from the spirit and scope of the present invention. It is therefore intended that the appended claims cover all such modifications, alterations and other changes.

### EXAMPLE 1

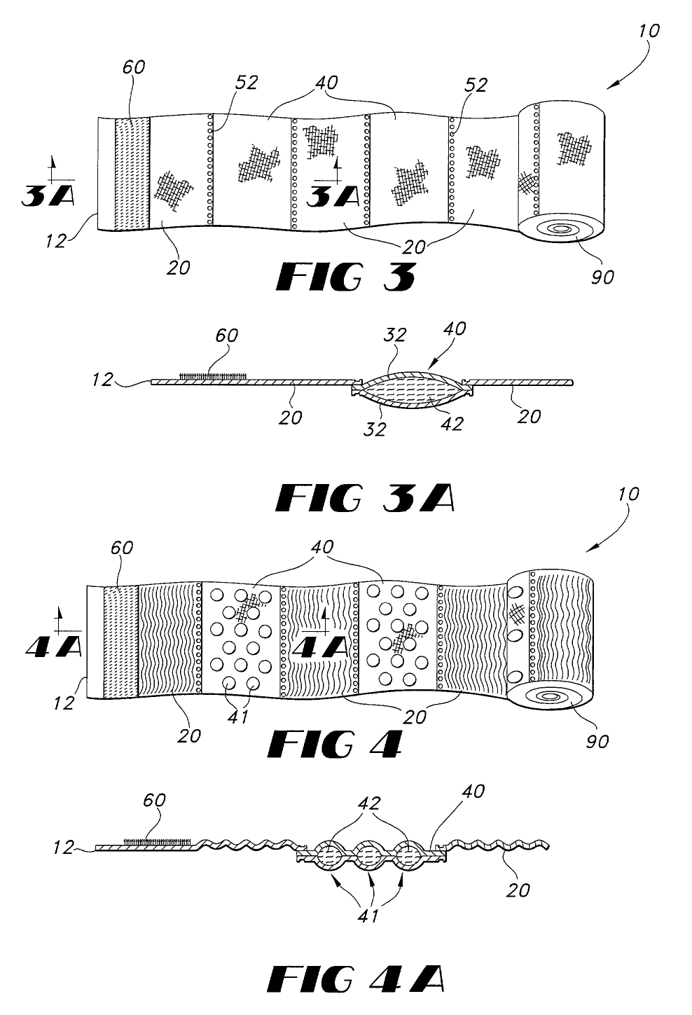

A 30-inch long by 4-inch wide thermal wrap 10 was prepared in conformance with the configuration illustrated in FIGS. 3 and 3A.

The thermal wrap 10 was prepared by first constructing heat transfer pockets, illustrated generally as thermal portions 40. Each thermal section 40 measured approximately 1.5 inches long by 4 inches wide and was prepared by bonding a 1.5 inch by 4 inch strip of an inelastic SMS laminate material 32 bonded to a similarly sized strip of SMS laminate material 32 around 11 grams of rice, a heat transfer material that was used as a thermal agent 42. Four sealed pockets containing 11 grams of rice were formed from the SMS laminate material. SMS is a nonwoven laminate material manufactured by Kimberly-Clark Corporation and can be nonelastic by using inelastic polypropylene. This SMS nonwoven material had a total laminate basis weight of 1.5 ounces per square yard (osy). The pockets were manufactured and sealed by ultrasonic bonding using 500 millisecond (msec) bond time and 300 m/sec hold time at 60 pounds per square inch (psi) air pressure. A Branson model 920 iw plunge bonder was fitted with a 6×1 inch smooth horn and a 6×0.25 inch female knurled anvil to bond the pockets.

Elastic portions 20 consisted of 4-inch wide lengths of a vertical filament laminate (VFL) elastic material, also manufactured by Kimberly-Clark Corporation. The VFL nonwoven material was manufactured by laminating 1 osy spunbond facing and KRATON elastomeric filaments using the methods described in PCT International Publication Nos. WO 01/87589 and WO 01/88245 which are both hereby incorporated by reference herein in their enitireties. The VFL nonwoven material had a stretch-to-stop ratio of 2:1.

The thermal wrap 10 was prepared by bonding four 1.5-inch long thermal portions 40 to 1.5 inch long elastic portions 20 along bond lines 52 end to-end in an alternating fashion as illustrated in FIGS. 3 and 3A. The four thermal portions were separated by 1.5-inch long elastic portions bonded to an additional 3-inch long by 4-inch wide elastic portion of VFL at one end of a heat transfer section to form an insulative leader having a leading edge 12. An additional elastic section, a 16.5-inch long by 4-inch wide strip of VFL (not illustrated) was bonded to the other end of the fourth pocket to make a thermal wrap having a total length of 30 inches. Additional lengths of material can be added to provide additional compression and/or insulation.

The thermal wrap 10 was heated by placing the entire wrap in a microwave oven with a power rating of 800 watts for 20 seconds. The heat transfer material became warm to the touch. The heated wrap was then wrapped around a body part, starting at the leading end 12, which as the end of the wrap closest to a pocket and thermal portion 42. Heat stored by the thermal agent 42 was transferred to the body part and was tempered by the insulation properties of the component wrap materials. The elastic portions 20 comprising VFL material provided mild compression and insulated the thermal agent from the room air, thus directing the heat that the wrap transfers to a wrapped body or body part.

### EXAMPLE 2

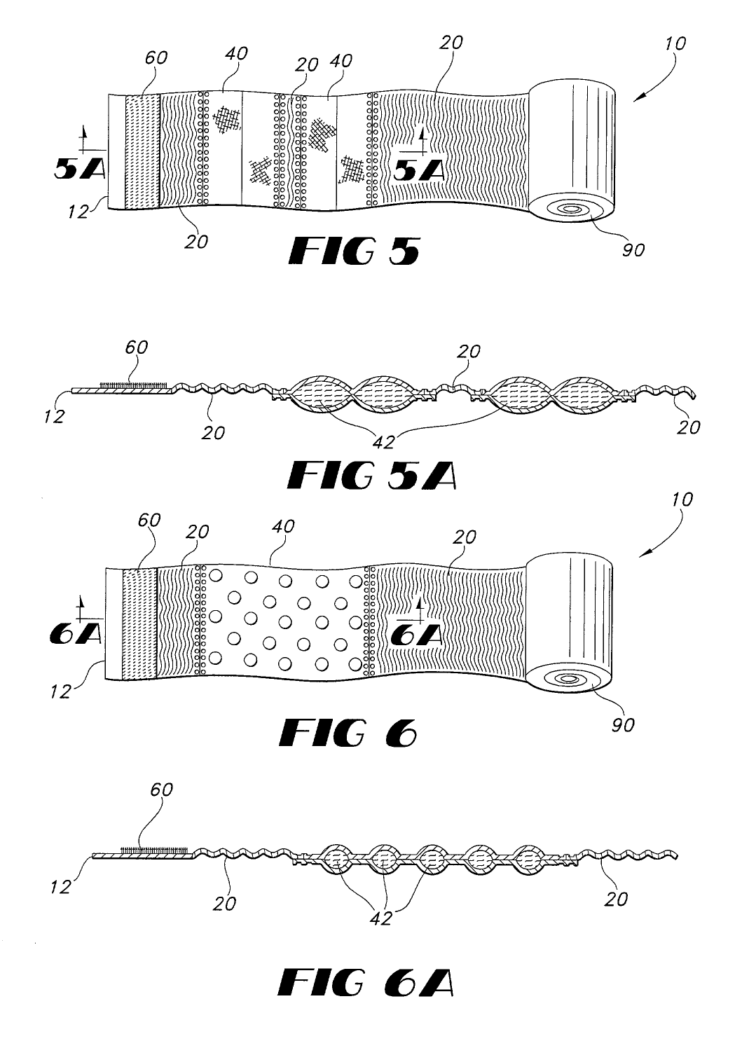

A thermal wrap 10 measuring 2 inches wide by 18 inches long was prepared in conformance with the configuration illustrated in FIGS. 4 and 4A.

The thermal wrap was prepared by first constructing 2-inch wide by 2.5-inch long thermal portions, illustrated generally as portions 40 in FIGS. 4 and 4A. In this embodiment and the embodiment of Example 1, the thermal portions 40 were non-extensible. The thermal portions 40 were made by laminating together two layers of SMS laminate with a point-unbonded pattern so that discrete pockets 41 containing thermal agent 42 were formed around 0.5-inch circular pockets of an thermal agent. A set of metal plates with 0.5 inch circular perforations staggered to yield a hexagonal pattern of pockets 41 was used in a Carver press to provide heat and pressure to form the pocketed SMS laminate thermal sections 40.

Each of the discrete pockets 41 was filled with 250 milligrams of a phase change material as the thermal agent 42. The phase change material was a low molecular weight hydrocarbon with a melting point of 127° C. adsorbed onto silica powder (catalog number 127MHP) manufactured by Phase Change Laboratories, Inc. of San Diego, Calif. Thermal bonding was performed at 150° C. and 30,000 psi hydraulic pressure for 150 seconds. Two 2-inch wide by 2.5-inch long sections 40 were prepared using the above procedure. Each section 40 had 10 to 12 of the pockets 41 containing phase change material 42 for a total of 5 grams of phase change material in the total wrap.

Elastic sections 20 consisted of lengths of a self-adhesive stretch-bonded laminate (SBL) elastic material. The self-adhesive SBL material is manufactured by Kimberly-Clark Corporation of Neenah, Wis. and is sold as a cohesive bandage. The cohesive bandage and methods of making the cohesive bandage are described in U.S. Pat. No. 5,503,908.

The thermal wrap 10 was prepared by joining a 4-inch long elastic section to a 2.5-inch long heat transfer section to a 1-inch long elastic section to a 2.5-inch heat transfer section to a 3-inch long section to produce an 18 inches long by 2-inch wide thermal wrap. The wrap assembly including all sections and bonds were made by ultrasonic bonding using 500 msec bond time and 300 msec hold time at 60 psi air pressure. The Branson model 920 iw plunge bonder was fitted with a 6×1 inch smooth horn and a 4×0.25 inch male knurled anvil.

Thermal wrap 10 was heated by placing the entire wrap in a microwave oven with a power rating of 800 watts for 15 seconds. The heat transfer material and wrap became warm to the touch. The heated wrap was then wrapped around a body part, starting at the leading end 12 closest to a thermal portion 40. Heat stored by the thermal agent 42 was transferred to the body part but was tempered by the insulation properties of the component wrap materials. The SBL material also provided mild compression and insulated the heat transfer material from the room air, thus conserving the heat for the wrap to transfer to a wrapped body or body part.

### EXAMPLE 3

A 30-inch long by 4-inch wide thermal wrap 10 was prepared in conformance with the configuration illustrated in FIGS. 7 and 7A.

The thermal wrap 10 was prepared by first constructing heat transfer pockets, illustrated generally as thermal sections 40. Each thermal section was a pocket measuring approximately 1.5 inches long by 4 inches wide and was prepared by bonding a 1.5 inch by 4 inch strip of SMS laminate material 32 to a similarly sized strip of SMS laminate material 32 around 11 grams of rice, thermal agent 42. Four sealed pockets containing 11 grams of rice each were formed from the SMS laminate material. This SMS laminate material had a total laminate basis weight of 1.5 osy. The pockets were manufactured and sealed by ultrasonic bonding using 500 msec bond time and 300 msec hold time at 60 pounds psi air pressure. A Branson model 920 iw plunge bonder was fitted with a 6×1 inch smooth horn and a 6×0.25 inch female knurled anvil to bond the pockets.

The elastic portion 20 was a continuous sheet of elastic material to which the thermal sections 40 were attached. The elastic portion consisted of 4-inch wide by 30-inch long vertical filament laminate (VFL) elastic material manufactured by Kimberly-Clark Corporation. The VFL nonwoven material was manufactured by laminating 1 osy spunbond facing and KRATON elastomeric filaments using the methods described in PCT International Publication Nos. WO 01/87589 and WO 01/88245 and with a stretch-to-stop ratio of 2:1.

The thermal wrap 10 was prepared by bonding the four 1.5-inch long thermal portions 41 to the elastic material 20 along bond lines 50 on one end only as illustrated in FIGS. 7 and 7A. The bond lines were across the width of the elastic wrap such that most of the elasticity was maintained. Bond lines parallel to the length of the elastic wrap were avoided as bond lines in this direction reduce the elasticity of the VFL material. The distance between the bond lines was approximately 1 inch, such that with the elastic material in a relaxed state the thermal portions 40 overlapped each other slightly.

The thermal wrap 10 was heated by placing the entire wrap in a microwave oven at a power rating of 800 watts for 20 seconds. The thermal agent and the thermal sections became warm to the touch. The heated wrap 10 was then wrapped around a body part, starting at the leading end 12, which as the end of the wrap closest to a thermal portion 40 and thermal agent 42 contained therein. The distance between the bond lines 50 increased as the elastic base sheet/elastic portion 20 stretched during wrapping, so there was less or no overlap of the thermal portions. Heat stored by the thermal agent 42 was transferred to the body part and was tempered by the insulation properties of the component wrap materials. The VFL material provided mild compression and insulated the heat transfer material from the room air, thus conserving the heat that the wrap can transfer to a wrapped body or body part.

### EXAMPLE 4

A 30-inch long by 4-inch wide thermal wrap 10 was prepared in conformance with the configuration illustrated in FIGS. 8 and 8A.

The thermal wrap 10 was prepared by first constructing heat transfer pockets, illustrated generally as thermal portions 40. Each of the pockets was a tube that measured approximately 0.375 inches in diameter by 4 inches wide and was prepared by folding and bonding a 1.5 inch by 4 inch strip of SMS laminate material 32, with the fold and the bond in the 4 inch dimension. The resulting ¾ inch by 4 inch tube had a fold on one edge and a bond on the other. One end of the tube was ultrasonically bonded and the tube was then inverted, leaving the bonded edge and end on the inside of the tube. Each tube was filled with 2 grams of low molecular weight hydrocarbon with a melting point of 127° C. adsorbed onto silica powder by Phase Change Laboratories, Inc., San Diego, Calif. catalog number 127MHP as the thermal agent. The SMS nonwoven material had a total laminate basis weight of 1.5 ounces per square yard (osy). The pockets were manufactured and sealed by ultrasonic bonding using 500 millisecond (msec) bond time and 300 msec hold time at 60 pounds per square inch (psi) air pressure. A Branson model 920 iw plunge bonder was fitted with a 6×1 inch smooth horn and a 6×0.25 inch female knurled anvil to bond the pockets.

The elastic portion 20 consisted of 4-inch wide by 30-inch long vertical filament laminate (VFL) elastic material, also manufactured by Kimberly-Clark Corporation. The VFL nonwoven material was manufactured by laminating 1 osy spunbond facing and KRATON elastomeric filaments using the methods described in PCT International Publication Nos. WO 01/87589 and WO 01/88245 and a stretch-to-stop ratio of 2:1.

The thermal wrap 10 was prepared by bonding the twelve 0.375-inch diameter heat transfer tubes 42 to the elastic material 20 at bond points 50 at each end of the tube near the edges of the wrap as illustrated in FIGS. 8 and 8A. The spacing between the tubes was approximately 0.5 inch. The first tube was bonded approximately 4 inches from an end of the wrap and, with tubes every 0.5 inches, the heat transfer section continued to approximately 10 inches from the starting end of the wrap. The remaining 20 inches of the 30 inch wrap was for insulation and compression.

The thermal wrap 10 was heated by placing the entire wrap in a microwave oven at a power rating of 800 watts for 20 seconds. The heat transfer material and wrap became warm to the touch. The heated wrap was then wrapped around a body part, starting at the leading end 12 which as the end of the wrap closest to a pocket 41 and heat transfer material 42. The distance between the bonded tubes increased as the material stretched during wrapping. Heat stored by the heat transfer material 42 was transferred to the body part and was tempered by the insulation properties of the component wrap materials. The VFL material provided mild compression and insulated the heat transfer material from the room air, thus conserving the heat that the wrap can transfer to a wrapped body or body part.

### EXAMPLE 5

A 30-inch long by 4-inch wide thermal wrap 10 was prepared in conformance with the configuration illustrated in FIG. 9.

The thermal wrap 10 was prepared by first constructing heat transfer pockets, illustrated generally as thermal portions 40. Each heat transfer pocket measured approximately 1.5 inches long by 4 inches wide and was prepared by bonding a 1.5 inch by 4 inch strip of SMS laminate material 32 bonded to a similarly sized strip of SMS laminate material 32 around 11 grams of rice, a heat transfer material 42. Four sealed pockets containing 11 grams of rice each were formed from the SMS material. This SMS nonwoven material had a total laminate basis weight of 1.5 osy. The pockets were manufactured and sealed by ultrasonic bonding using 500 msec bond time and 300 msec hold time at 60 pounds per square inch (psi) air pressure. A Branson model 920 iw plunge bonder was fitted with a 6×1 inch smooth horn and a 6×0.25 inch female knurled anvil to bond the pockets.

The elastic portions 20 and 30 consisted of 4-inch wide by 30-inch long vertical filament laminate (VFL) elastic material, also manufactured by Kimberly-Clark Corporation and a 4-inch wide by 6-inch long section of the same material. The VFL nonwoven material was manufactured by laminating 1 osy spunbond facing and KRATON elastomeric filaments using the methods described in PCT International Publication Nos. WO 01/87589 and WO 01/88245. The VFL nonwoven material had a stretch-to-stop ratio of 2:1.

The thermal wrap 10 was prepared by bonding the four 1.5-inch long thermal portions 40 to the 4-inch by 30-inch elastic portion 20 along bond lines 50 on one end only as illustrated in FIG. 9. The bond lines were across the width of the elastic wrap such that most of the elasticity is maintained. Bond lines parallel to the length of the elastic wrap were avoided as bond lines in this direction reduce the elasticity of the VFL material. The distance between the bond lines was approximately 1 inch, such that with the elastic material in a relaxed state, the heat transfer sections overlapped each other slightly. The other edges of the heat transfer section were then bonded to a 4-inch by 6-inch elastic material 30 at 1-inch intervals to form a ladder-like structure with the pockets as rungs. The ends of the 6-inch long elastic material were bonded to the 30-inch long elastic material with bonds perpendicular to the length of the wrap. The 6-inch long elastic material kept the heat transfer sections laying against the 30-inch long section yet permitted the entire structure to stretch.

The thermal wrap 10 was heated by placing the entire wrap in a microwave oven at a power rating of 800 watts for 20 seconds. The heat transfer material and wrap became warm to the touch. The heated wrap was then wrapped around a body part, starting at the leading end 12, which as the end of the wrap closest to a thermal section 40 and the thermal agent 42 contained therein. The distance between the bond lines increased as the material stretched during wrapping, so there was less or no overlap of the heat transfer sections. Heat stored by the thermal agent 42 was transferred to the body part and was tempered by the insulation properties of the component wrap materials. The VFL material provided mild compression and insulated the heat transfer material from the room air, thus conserving the heat that the wrap can transfer to a wrapped body or body part.

### EXAMPLE 6

Wraps similar to the wrap illustrated in FIGS. 1 and 1A can be made by joining two elastic sheets 20 and 30 together, for example two elastomeric nonwovens, around a thermal agent to form pockets containing thermal agent as part of the structure as illustrated. Grains of rice can be used as the thermal agent. A stretch-bonded laminate (SBL) elastic material can be used as the elastomeric nonwoven base sheet. Elastomeric nonwovens are manufactured by and are commercially available from Kimberly-Clark Corporation.

Ultrasonic bonding may be used to laminate the upper and lower elastomeric materials. The bonding pattern can be a series of discrete bond points 52 to minimize the effect on the elasticity of the material. Solid, continuous bonds significantly reduce the elasticity of the material. 0.0625 inch pins with a 0.125 inch center-to-center spacing is a bonding pattern that worked to contain the granular heat transfer material yet maintained the elasticity of the structure. The edges of the elastomeric sheets were bonded to contain the thermal agent with the sheets and additional bonds were made across the web to keep the heat transfer material evenly distributed across the wrap and limit the thickness. The bonds across the web were perpendicular to the long axis at the ends of the thermal portions, and 30 degrees off of perpendicular through the rest of the thermal portions, forming a series of equilateral triangles. Other bonding patterns are possible and known to those of skill in the art.

The bonding was ultrasonic bonding using 500 msec bond time and 300 msec hold time at 60 psi air pressure. The Branson model 920 iw plunge bonder was fitted with a 6×1 inch smooth horn and the anvil had 0.0625 inch diameter pins with a 0.125 inch center-to-center spacing. In use, the entire structure stretches in the direction of the length of the wrap.

1. A wrap comprising:
a first thermal portion containing a thermal agent,
a second thermal portion containing a thermal agent, and
an elastic portion connecting the first thermal portion to the second thermal portion.

2. The wrap of claim 1 wherein the elastic portion is stretchable and elongatable by at least about 50 percent upon application of an elongating force and will return to within 10 percent of its original length upon release of the elongating force.

3. The wrap of claim 1 wherein the elastic portion is stretchable and elongatable by at least about 50 percent upon application of an elongating force and will return to within 5 percent of its original length upon release of the elongating force.

4. The wrap of claim 1 wherein the elastic portion is stretchable and elongatable by at least about 100 percent upon application of an elongating force and will return to within 10 percent of its original length upon release of the elongating force.

5. The wrap of claim 1 wherein the elastic portion is stretchable and elongatable by at least about 100 percent upon application of an elongating force and will return to within 5 percent of its original length upon release of the elongating force.

6. The wrap of claim 1 wherein the elastic portion is stretchable and elongatable by at least about 200 percent upon application of an elongating force and will return to within 10 percent of its original length upon release of the elongating force.

7. The wrap of claim 1 wherein the thermal agent is selected from the group consisting of iron oxidation mixtures, phase change materials, ceramic beads, natural grains, minerals, gels, hydrogels, water and water-containing compositions.

8. The wrap of claim 1 wherein the thermal agent is capable of being heated by microwaves or is capable of being cooled by refrigeration.

9. The wrap of claim 1 further comprising a third thermal portion containing a thermal agent and an elastic portion connecting the third thermal portion to the first thermal portion or the second thermal portion.

10. The wrap of claim 1 wherein the elastic portion between the first thermal portion and the second thermal portion comprises an elastic nonwoven material and the first portion and the second portion comprise pockets that are attached to the elastic nonwoven material.

11. The wrap of claim 10 wherein the first thermal portion and the second thermal portion comprise pockets that are attached to the elastic nonwoven material along only a portion of their perimeters.

12. The wrap of claim 11 wherein said first elastic portion and the second elastic portion each comprise a pocket that contains a thermal agent and having at least one edge that is attached to the elastic nonwoven material.

13. The wrap of claim 1 further comprising a closure.

14. A roll of elastic thermal wrap comprising:
an elastic sheet comprising a first end defining a width of the sheet and the sheet having a length that is greater than the width, and
a plurality of thermal cells disposed on or attached to a surface of the elastic sheet
wherein the thermal cells move relative to each other upon application of an elongating force to the elastic sheet and the elastic sheet is stretchable and elongatable by at least about 40 percent upon application of the elongating force to the elastic sheet and the elastic sheet returns to within 10 percent of its original length upon release of the elongating force.

15. The roll of claim 14 further comprising a closure proximate to one end of the elastic sheet.

16. The roll of claim 15 wherein the closure is a hook portion of a hook and loop fastener and can fasten to a surface of the elastic sheet.

17. The roll of claim 14 further comprising a line of perforations or a line of weakness extending across the width of the elastic sheet.

18. The roll of claim 17 further comprising a second line of perforations or second line of weakness extending across the width of the elastic sheet.

19. The roll of claim 17 further comprising a first closure proximate one end of the elastic sheet and a second closure proximate the line of perforations or the line of weakness.

20. The roll of claim 14 wherein the roll can wrap around a rod having a diameter of less than 2 centimeters and can stretch to at least twice its original length by the application of a force within the range of normal human forces and will return to substantially the original length upon removal of the force.

21. A thermal wrap comprising
a thermal agent,
a first elastic sheet,
a second elastic sheet joined to the first elastic sheet to form a plurality of pockets containing thermal agent.

22. The wrap of claim 21 wherein the wrap is stretchable and elongatable by at least about 50 percent upon application of an elongating force and will return to within 10 percent of its original length upon release of the elongating force.

23. The wrap of claim 21 wherein the wrap is stretchable and elongatable by at least about 50 percent upon application of an elongating force and will return to within 5 percent of its original length upon release of the elongating force.

24. The wrap of claim 21 wherein the wrap is stretchable and elongatable by at least about 100 percent upon application of an elongating force and will return to within 10 percent of its original length upon release of the elongating force.

25. The wrap of claim 21 wherein the wrap is stretchable and elongatable by at least about 100 percent upon application of an elongating force and will return to within 5 percent of its original length upon release of the elongating force.

26. The wrap of claim 21 wherein the wrap is stretchable and elongatable by at least about 200 percent upon application of an elongating force and will return to within 10 percent of its original length upon release of the elongating force.

27. The wrap of claim 21 wherein the first elastic sheet and the second are joined by a series of discrete bond points.
